(19) United States
(12) Patent Application Publication
(10) Pub. No.: US 2009/0024234 A1
(43) Pub. Date: Jan. 22, 2009

(54) Apparatus and method for coupling two independent audio streams

(76) Inventor: Fitzgerald J. Archibald, Thuckalay (IN)

Correspondence Address: TEXAS INSTRUMENTS INCORPORATED, P O BOX 655474, M/S 3999, DALLAS, TX, 75265, US

(21) Appl. No.: 11/901,541

(22) Filed: Sep. 18, 2007

Related U.S. Application Data
(60) Provisional application No. 60/961,142, filed on Jul. 19, 2007.

(51) Int. Cl. G06F 17/00

(52) U.S. Cl. 700/94

(57) ABSTRACT

In providing a seamless transition between two audio Streams using the cross-fade technique, a clock rate in processing the current audio Stream is increased. The increased audio Stream processing rate permits the current audio Stream to finish processing the initial audio Stream by the beginning of the fade-out or fade-in duration period, whichever is longer. The initial audio Stream continues to be presented at the original clock rate, even during the fade-out and/or fade-in duration. However, the portion of the initial audio Stream that is to be played during the fade-in and/or fade-out portion of the presentation is stored in a memory unit. During the Cross-Fade Duration, the portion of the initial audio Stream stored in the memory unit is retrieved and combined with a second audio Stream according to the cross-fader algorithm.

This application claims priority under 35 USC §119(e)(1) of Provisional Application No. 60/961,142 (TI-63076), filed Jul. 19, 2007.

### BACKGROUND OF THE INVENTION

1. Field of the Invention

The present invention relates generally to an apparatus and method for coupling two independent audio tracks. In particular, the technique referred to as cross-fading is used to provide a seamless coupling of the tracks, the original audio track being subject to a fade-out while the new track is subject to a fade-in.

2. Description of the Related Art

The cross-fade of an audio Stream refers to mixing of end of a current audio Stream and beginning of a next audio Stream to produce seamless audio Stream. This process is illustrated by FIG. 1. During the period of time designated as the Cross-Fade Duration, audio Stream 1 has the amplitude attenuated (i.e., fade-out) while audio Stream 2 is being simultaneously amplified (i.e., fade-in). When audio Stream 1 is at a maximum at the beginning of the Cross-Fade Duration, audio Stream 2 is initiated at a minimum amplitude. During the Cross-Fade Duration, audio Stream 1 is continuously attenuated, whereas audio Stream 2 is continuously amplified. At the end of the Cross-Fade Duration, audio Stream 1 reaches a minimum amplitude before being switched off, while audio Stream 2 has reached a maximum amplitude, the same amplitude as audio Stream 1 prior to entering the Cross-Fade Duration interval. The gain change on outgoing audio Stream 1 causes audio Stream 1 to fade out. That is, the audio Stream is gradually reduced in volume. The gain change on incoming audio Stream 2 is caused to fade-in, referring to the gradual increase in volume. The duration for which the incoming and outgoing Streams overlap in time is referred to as Cross-Fade Duration. The fade-out duration (time taken for fade-out of outgoing Stream) need not be same as fade-in duration. Also, the gain curve during fade-in of audio Stream 2 need not match the attenuation curve of audio Stream 1. Though various gain curves are possible for fade-in and fade-out, the most effective for cross-fade is linear gain change (with respect to amplitude voltage). In practice, the recording industry applies fade-out and fade-in to audio Streams, fade-in and fade-out duration, and gain curve shapes with non-standardized protocols.

Referring now to FIG. 2, the conventional apparatus for reproducing audio with cross-fade effect is illustrated. Because the cross-fade procedure requires two audio Streams 11, 21 be processed simultaneously, two decoders, 12 and 22, and two post processing modules, 14 and 24, are needed to process the Streams. The common algorithms for the post processing units are an equalized procedure and/or a base/treble procedure. The gain curve can be programmed into a set of points. The gain curve or envelope which is linear, quarter-cosine, logarithmic, or any other shape, can be realized by changing the gain at predefined intervals from a look-up table containing interval and gain value. The time can be monitored from sample count and sample rate.

Reproducing systems can be expected to support various compressed audio formats such as MP3, AAC, and WMA. (Reproducing systems also might be expected to support compressed lossless Streams such as WMA lossless along with uncompressed PCM samples WAV format). To be able to sum two audio Streams, both Streams need to have the same sample rate. Thus, the reproducing systems should be capable of playing all supported sample rates. Typical sample rates for audio are 8, 11.025, 12, 16, 22.05, 24, 32, 44.1, 48, and 96 KHz.

The conventional cross-fade apparatus requires a higher memory requirement for codec, along with algorithm data memory and Streaming buffers, because of the two instances of decoder and post-processing modules. The codec program memory also can increase if the Streams to be cross-faded are encoded in different audio formats. Streaming buffers are data buffers carrying data between various elements within the apparatus such as decoder, SRC (sample rate converter), and XFC (cross-fade controller). The hardware for portable audio-players consists of one or more processor(s), limited on-chip memory, and peripherals. The processor can be a general purpose processor (GPP) with digital signal processor (DSP) extensions or a DSP. In systems where on-chip memory is low, placing of simultaneous two audio playback systems, required for cross-fade procedures, becomes challenging in terms of memory. The memory constraint solution is to overlay the on-chip memory region with code and data that are mutually exclusive in-terms of program execution. The modules that need to be executed are loaded to on-chip memory from external memory before execution commences. Once the execution is completed, the next module that needs to be executed is overlaid on top of the current module in on-chip memory, after the state of present module is saved in external memory and/or on-chip memory that are not used for the overlay process. The reproducing system with excessive overlay is less efficient in terms of power efficiency due to overlay execution cycle overhead, and frequent external memory access.

A need has been felt for apparatus and an associated method having the feature of providing an efficient cross-fade procedure for the merging of two audio Streams. It would be yet another feature of the apparatus and associated method to provide for temporary storage of the portion of a first audio Stream that will be part of the cross-fade procedure. It would be a still further feature of the apparatus and associated method to process and store the portion of the first audio Stream to be combined with a portion of the second audio Stream. It would be a more particular feature of the apparatus and associated method to speed up the clock of the apparatus processing the first audio Stream in order to synchronize the cross-fading procedure of the last portion of the first audio Stream with the first portion of the second audio Stream. It would be yet another particular feature of the apparatus and associated method to synchronize the beat of the two audio Streams involved in the cross-fade procedure.

### SUMMARY OF THE INVENTION

The aforementioned and other features of the apparatus and associated method are accomplished, according to the present invention, by providing the apparatus implementing the cross-fade procedure with a storage unit that stores the last portion of the processed audio Stream currently being performed. This last portion of the current audio Stream portion is retrieved and included in a cross-fade operation with the first portion of a second audio Stream. The second audio Stream is to begin just as the first audio Stream is ending. The clock of the apparatus processing the first audio Stream is increased so that the portion of the first audio steam that is to be cross-faded with the second portion is synchronized. Further, the apparatus consists of a means to set cross-fade duration (fade-out duration and fade-in duration), and fade curve shape (gain curve). The gain curve can be selectable to be linear, quarter-cosine, logarithmic or any other shape (customizable). The apparatus consists of samples reservoir in external memory large enough to hold the audio samples PCM (Pulse Code Modulation) corresponding to Cross-Fade Duration. The sample rate of the PCM samples is configurable by setting sample rate converter output sampling frequency.

The process of the cross-fade procedure is summarized as detecting the buffering start time, detecting the cross-fade start time, detecting the real time mix, Streaming the data, reading data faster than normal playback speed (from Stream source), executing the cross-fade procedure, and converting to an analog data Stream for application to an output device.

### BRIEF DESCRIPTION OF DRAWINGS

FIG. 1 illustrates the cross-fade procedure for merging two audio Streams according to the prior art.

FIG. 2 is an implementation of apparatus performing a cross-fade procedure according to the prior art.

FIG. 3 is an implementation of the apparatus for performing the cross-fade procedure according to the present invention.

FIG. 4 is a block diagram of cross-fade apparatus and method as in present invention;

FIG. 5 illustrates the state transitions diagram for the cross-fade procedure according to the present invention;

FIGS. 6A through 6M illustrate relevant portions of the apparatus for each state of FIG. 5.

FIG. 7 is a flow chart illustrating the operation of the cross-fade procedure according to the present invention.

FIG. 8 is a time-line illustration of the cross-fade procedure according to the present invention.

FIG. 9 illustrates a cross-fade algorithm according to the Equations in present invention to detect start of samples reservoir filling, and start of cross-fade; and

FIG. 10 illustrates a block diagram capable of implementing the cross-fade algorithm of FIG. 9 according to the present invention.

### DESCRIPTION OF THE PREFERRED EMBODIMENTS

### 1. Detailed Description of the Drawings

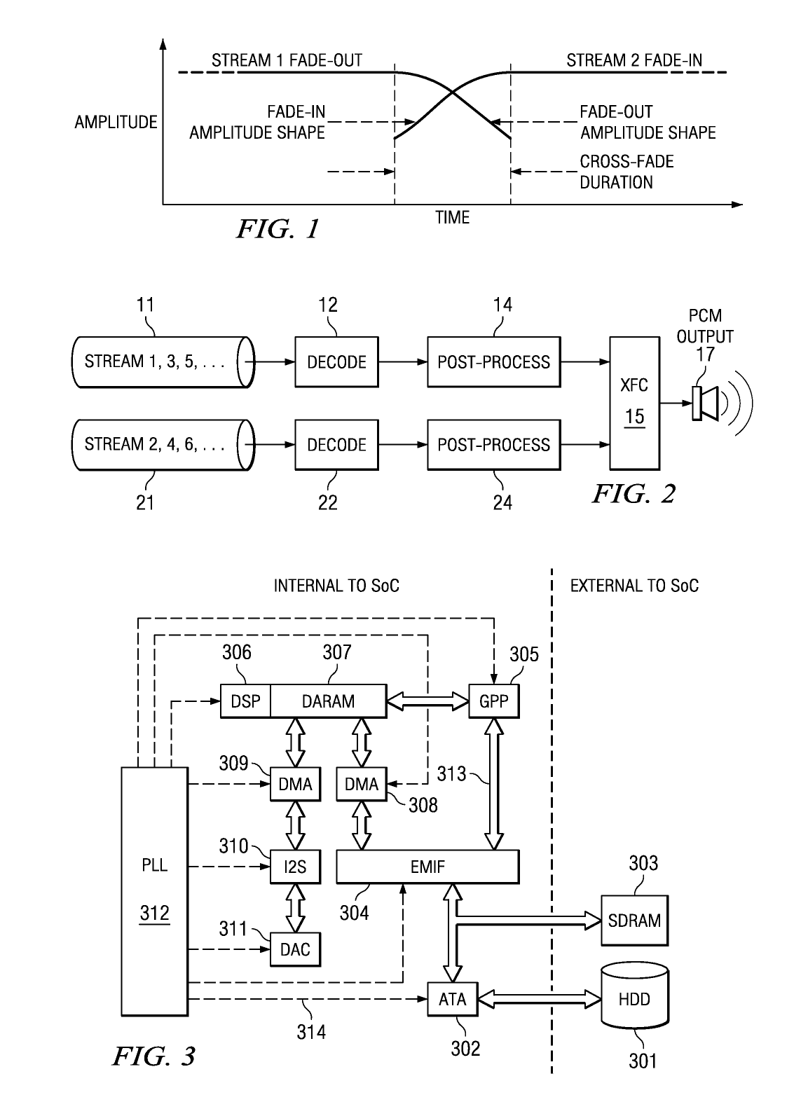

FIG. 1 and FIG. 2 have been described with respect to the prior art.

Referring to FIG. 3, an implementation of the apparatus for providing a cross-fade procedure according to the present invention is shown. The storage media 301 (e.g., hard drive disk) contains the one or both Streams to be cross-faded. The storage media is capable of providing data to external memory 303 (e.g., synchronous dynamic random access memory) and/or on-chip memory 307 (e.g., dual access dynamic random access memory) via an interface such as ATA (advanced technology attachment) 302. The audio Stream for cross-fade (compressed or uncompressed) in on-chip memory 307 is processed by DSP (digital signal processor) 306. The GPP (general purpose processor) 305 can contain DSP extension 306 and on-chip memory 307 in the case of a single core apparatus. The compressed/uncompressed Stream is stored in SDRAM 303 or retrieved from DARAM 307 by DSP/GPP 306/305 through the use of DMA (direct memory access unit) 305. EMIF (External Memory Interface) 304 provides interface to external memory (SDRAM) 303 for direct access by GPP/DSP 305/306 or DMA 308. The PCM samples are delivered to DAC (digital-to-analog converter) 311 by DMA 309 via 12S interface 310. The digital-to analog converter 311 can be external to the system-on-a-chip (SoC). An external crystal can be used to deliver a clock signal to the various peripherals, interfaces, and processor core in SoC. A PLL (phase-locked-loop) unit 312 can be used to derive different clock frequencies from a crystal by the use of multipliers and dividers. The PLL unit 312 can be programmed to a different set of frequencies for the processor core, depending upon the computational load. The programming of frequency would need voltage control of core as well (via GPIO or power management unit [PMU]) controlled through 12C interface 310. Dynamic clock change for the processor, during audio playback, can be achieved if the processor clock is decoupled with DAC/DMA 311/309 clock. The clock domain grouping (number of sets of clock frequencies) and isolation is not necessarily required as shown in FIG. 3.

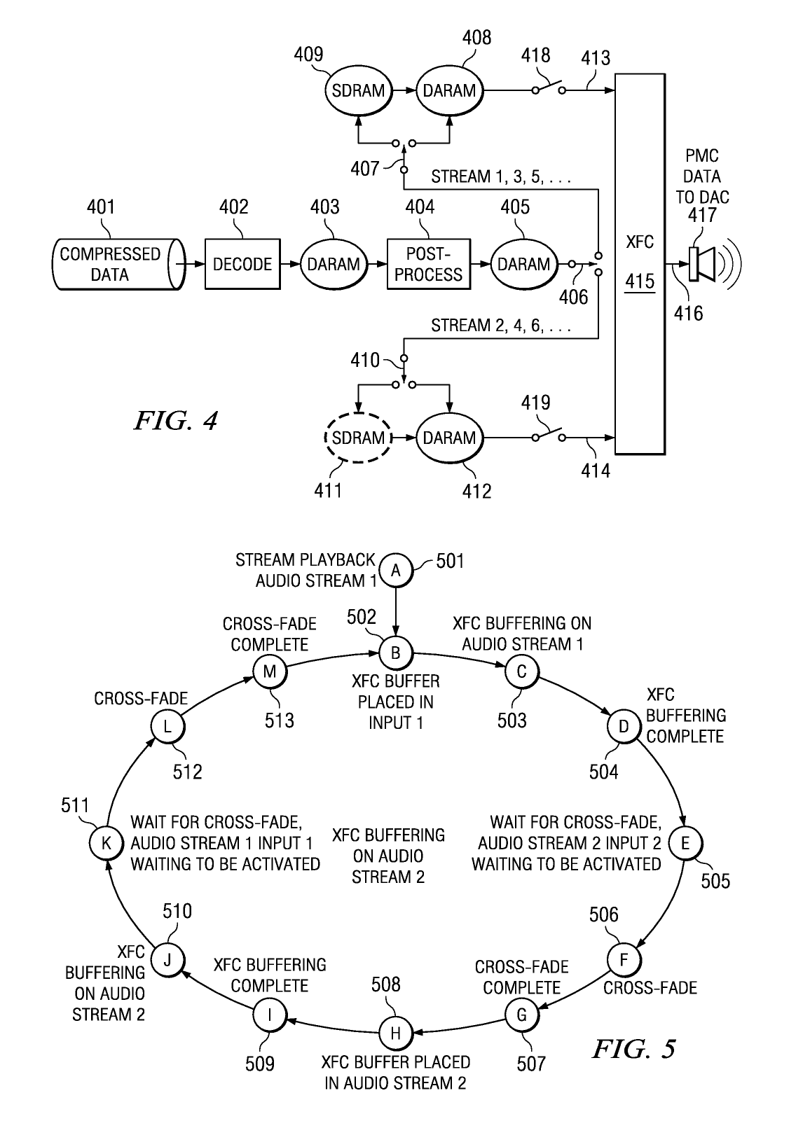

FIG. 4 shows a block diagram of the present invention. The compressed/uncompressed Stream 401 is transferred in small chunks from external memory to on-chip memory. The decoder program 402 decodes the compressed data Streaming buffers 403 in on-chip memory. If the Stream is uncompressed such as linear PCM in WAV format, the decoding operation would be simple Streaming or data pass through. The input Stream buffer 401 is refilled for consumed data for next frame decode. The decode data is processed by post-processing module 404. In the simplest configuration, the post-processing module can be an SRC. An SRC is essential to insure that the fade-in and fade-out Streams are converted to the same sample rate before passing the audio Streams on to XFC (cross-fade controller) 15. The post-processed data is available for Streaming in buffers 405 in the on-chip memory. The switch 406 controls the Streaming data to either switch 407 or 410. The odd numbered Streams are passed onto switch 407 and even numbered Streams are passed onto switch 410. The first Stream is odd and every subsequent Stream alternates between even and odd. The Stream here refers to the Streams for cross-fading. Initially switch 407 routes data to Streaming buffer 408. The switch 418 is in closed position delivering data to cross-fade input 413. The audio Stream passes through XFC 15 without any alteration to be buffered 416 or played back by the digital-to-analog 417. The external memory buffering 416 is needed only if program swap or memory overlay is needed to accommodate the reproducing apparatus in on-chip memory. The samples reservoir 409 is activated once the buffering time is met, by changing the switch 407 state. Real-time playback of audio continues by Streaming PCM samples through buffers 408 from samples reservoir. On reaching the end of a Stream for fade-out, switch 406 changes position to an even numbered Stream to 410, 412. The switch 419 will be held in open position to prevent Streaming of the fade-in audio Stream. On reaching fade start time, the switch 419 is closed to allow Streaming of data to XFC input terminal 414. The input from samples reservoir are applied to input 413 and decoded samples from input 414 are faded-out and fade-in respectively by XFC 415. The faded audio Streams are mixed by XFC 415 before outputting to digital-to-analog converter 417. Since the output is driven by DAC 417 periodically, the fade-in Stream will be available in real-time (both inputs and output are present) for cross-fade and delivery to digital-to-analog converter 417 when the digital-to-analog converter 417 finishes the present buffer playback. In the event of large PCM sample buffer following the XFC 15 (which may be needed for overlay application to control overlay frequency), the cross-fade operation has to be more tightly controlled, otherwise the samples reservoir would be emptied by the buffer following the cross-fade controller, by allowing cross-fade only if audio samples are available at both cross-fade converter inputs. In case of real-time miss reported by DAC 417 or bitStream error reported by decoder 402, the presence of both inputs is relaxed, so as to allow fade-out data Stream to continue playback until recovered from error. Once the samples reservoir is empty, the reservoir buffer is transferred to even Stream path 410. The samples reservoir and cross-fade operation starts from even Stream path as the timing conditions are met.

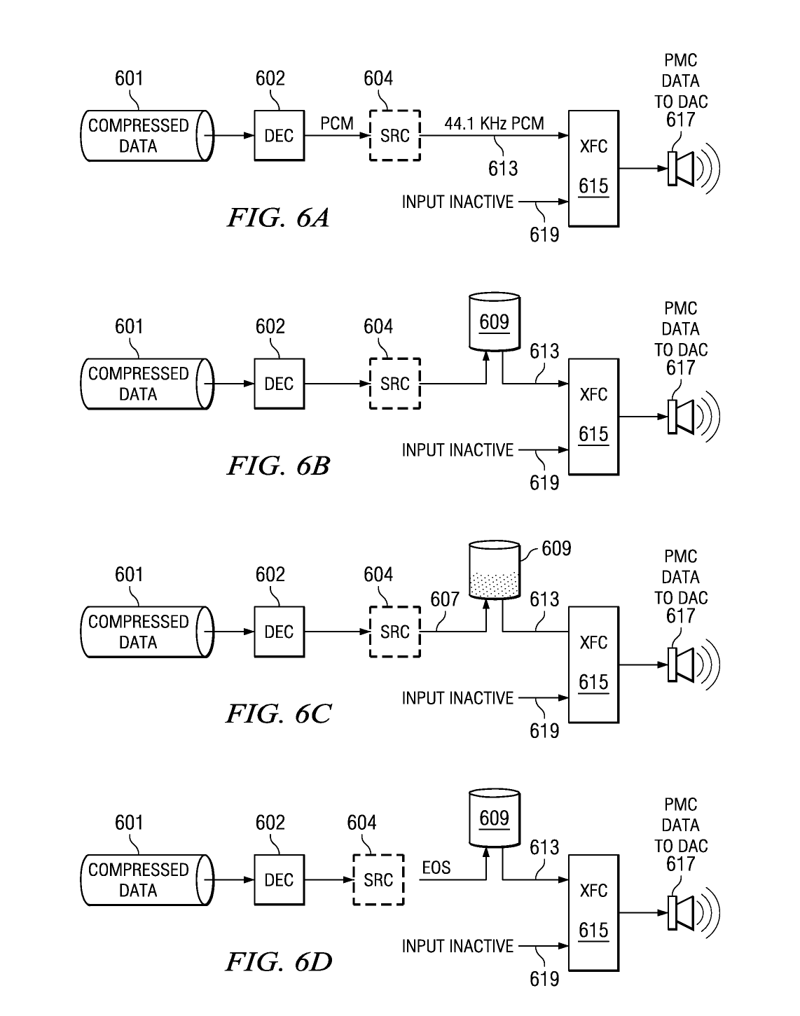

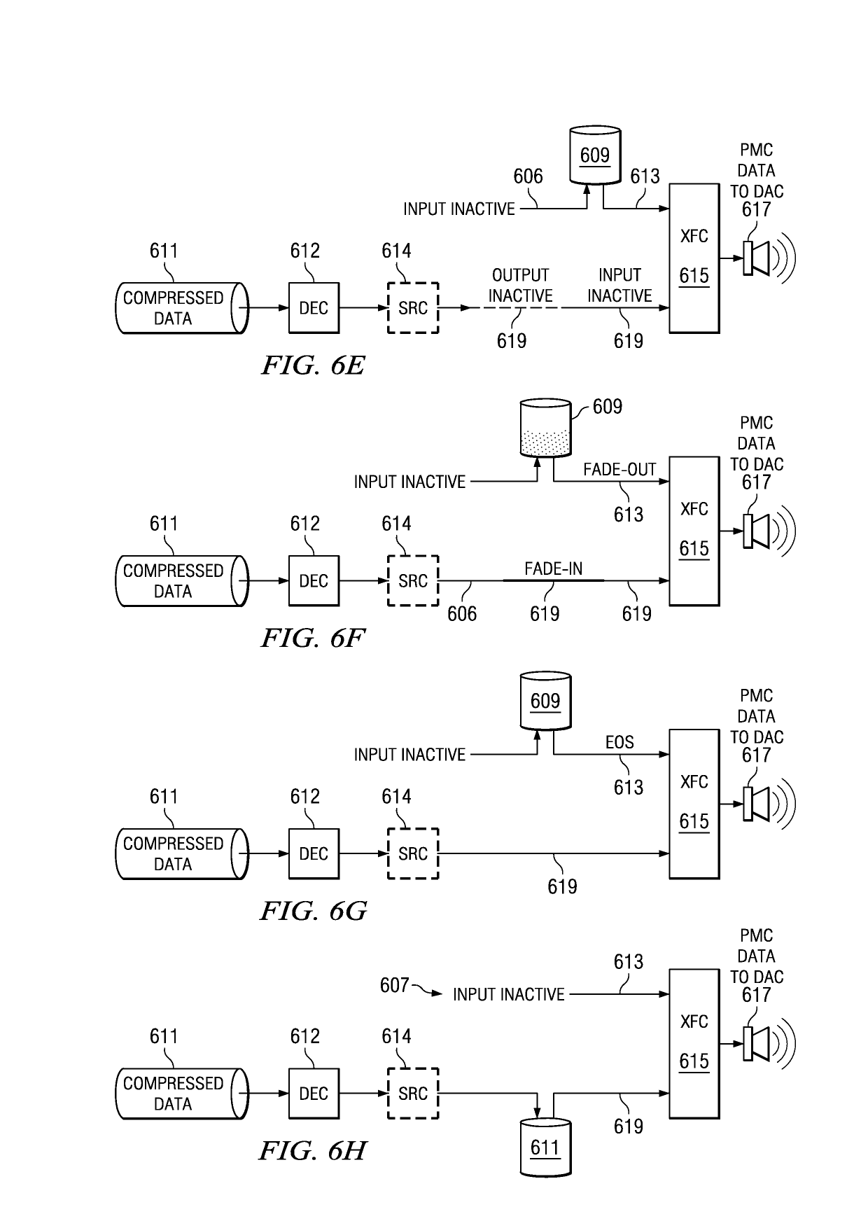

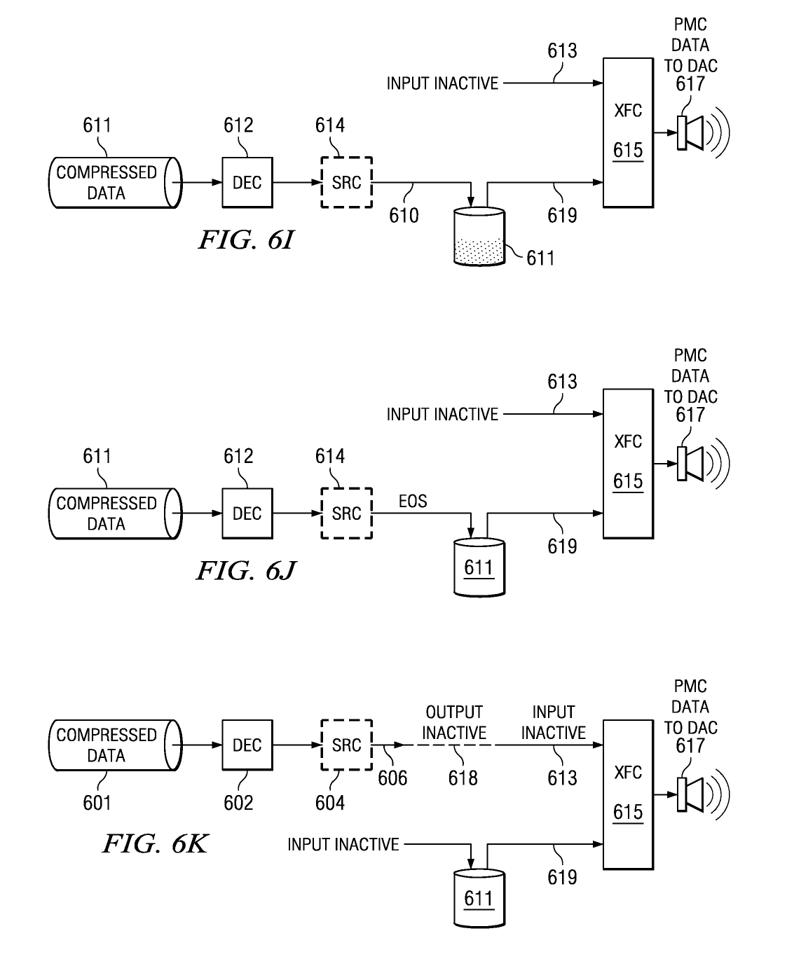

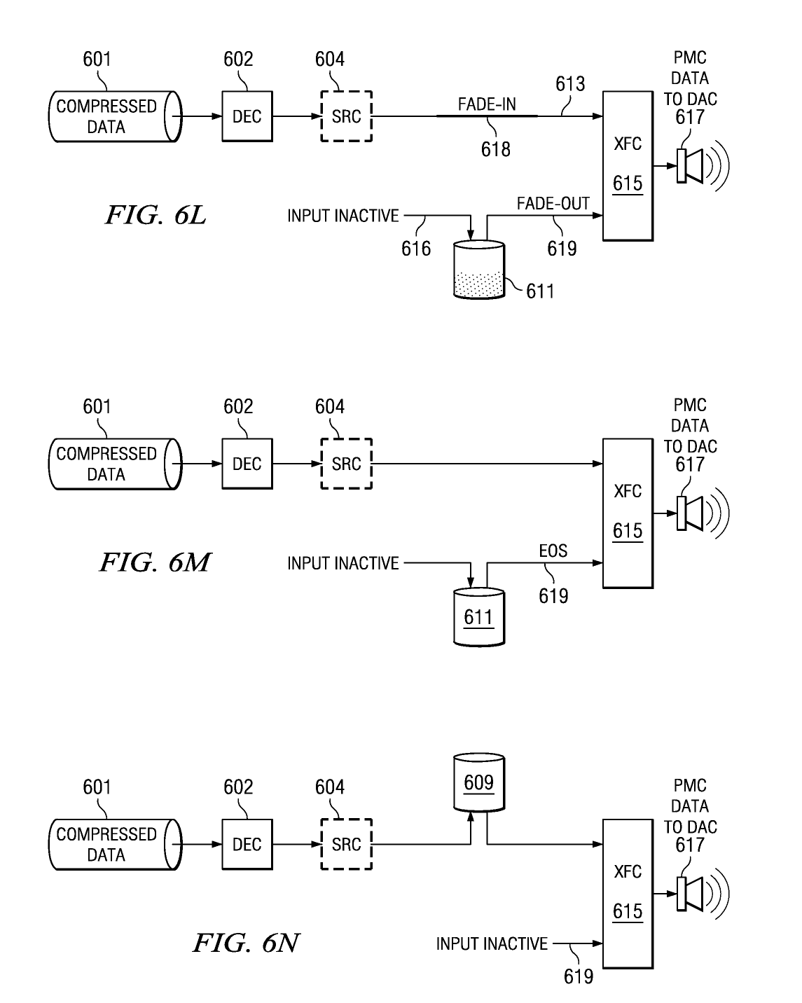

FIG. 5 illustrates the state transitions of the apparatus according to the present invention, while FIG. 6A through 6N summarizes the activity of the cross-fade apparatus associated with each state. The reproducing apparatus without the presence of cross-fade state 501 in FIG. 5 is illustrated by FIG. 6A. For simplicity of explanation, post-processing modules other than decoders 602, SRCs (sample rate converters) 604 are not shown. For reproducing apparatus without cross-fade, the SRC units are optional if digital-to-analog converter supports all sample rates, in the audio formats supported by the apparatus. The cross-fade controller 615 in FIG. 6A is set up for passing through the PCM (pulse code modulation) samples. In applications requiring soft-mute or unmute (mute, unmute, volume change, pause, resume, stop, start features of the reproducing apparatus), the cross-fade controller 615 can be used for achieving fade-in and fade-out, as required by soft mute/unmute, by configuring gain curves and disabling the mixing (summer and saturator).

The state 502 in FIG. 5 corresponds to FIG. 6B. When the cross-fade feature is enabled in the reproducing apparatus, samples reservoir 609, in FIG. 6B, which is large enough to buffer PCM samples whose playback time is greater-than or equal to larger of the fade-out and fade-in duration, is to be provided by apparatus. The samples reservoir 609 can be in external memory or on-chip memory. Until buffering time/reservoir filling time is reached, the data Streams to cross-fade controller 615 bypass the reservoir 609.

The state 503 in FIG. 5 is illustrated in FIG. 6C. When the buffering start time is reached, samples reservoir 609 is enabled. The buffering start time is the time from which onwards, if filling of samples reservoir is enabled, the samples reservoir would hold PCM samples to play for the duration of cross-fade procedure. The filling will be achieved before reaching the Cross-Fade Duration start time. When samples reservoir 609 is enabled, the decoded PCM samples are directed to samples reservoir 609. SRC 604 can be after samples reservoir, which would reduce samples Streamed in and out of reservoir 609 if SRC 604 converts lower sample rate Stream to higher sample rate. The digital-to-analog converter consumes PCM samples in groups. When the digital-to-analog converter consumes PCM group, the next PCM group is made ready by Streaming samples from samples reservoir 609 to cross-fade converter 613.

The state 504 in FIG. 5 corresponding to FIG. 6D illustrates the reception of end-of-Stream (EOS) of the first audio Stream by which time the samples reservoir 609 would contain samples equivalent to or exceeding fade-out duration. Once decoder 602 propagates the EOS (end-of-stream), the decoder 602 can be replaced with the decoder for next audio Stream.

The state 505 in FIG. 5 shows the decoding of fade-in Stream. The input to samples reservoir 609 is disconnected in FIG. 6E. The disconnected output of SRC 604 is not connected to cross-fade controller 614, thus preventing Streaming of fade-in Stream. The alternate method is to signal cross-fade controller 615 to NOT consume data from input 614.

The state 506 in FIG. 5 shows the cross-fading of two audio Streams, illustrated by FIG. 6F. Once the samples reservoir 609 holds samples equal-to or less-than the fade-duration, the fade-in Stream is fed to XFC input 14, thus starting up Streaming of fade-in Stream. The presence of both fade-in and fade-out Streams triggers the cross-fade algorithm to perform cross-fading of the two audio Streams with preconfigured gain curve. Alternately, if fade-in time is not-equal-to and less-than fade-out time, the samples reservoir 609 signals cross-fade controller 615 to start fading-out once the samples reservoir 609 level reaches less-than or equal-to fade-out duration. Once the sample reservoir 609 level reaches below or equal to fade-in duration, the fade-in operation is triggered, by connecting SRC 614 output to cross-fade controller input 615. If fade-in time is not-equal-to and greater-than fade-out time, fade-in is initiated by connecting SRC 614 output to cross-fade controller input 614, when the sample level reaches fade-in duration; fade-out is started by samples reservoir 609 signaling the cross-fade controller 615.

The state 507 in FIG. 5, illustrated by FIG. 6G, marks the end of cross-fade operation. Fade-out is complete when the samples reservoir 609 is empty OR the fade-out gain-curve reaches inaudible gain. The fade-in completes on reaching target gain OR the end of Stream whichever is the earlier.

The state 508 in FIG. 6H illustrates the sharing or transferring of samples reservoir 611 to the faded-in Stream; thus, preparing the faded-in Stream for fade-out operation. In case of abrupt ending of the fade-in Stream (before fade-out), the decoder 612 for next audio Stream format is loaded by the apparatus and the audio Stream starts fading-in. This state is identical to state 502 with cross-fade input pin roles swapped 613, 614 interchanged, as can be seen from comparison of FIG. 6B and FIG. 6H.

The states 509, 510, 511, 512, and 513 in FIG. 5 are identical to state 503, 504, 505, 506, and 507 with cross-fade input pins 613 and 614 can be seen by comparing FIG. 6I through FIG. 6M with FIG. 6C through FIG. 6G. The state 502 continues from state 513 shown in FIG. 6N.

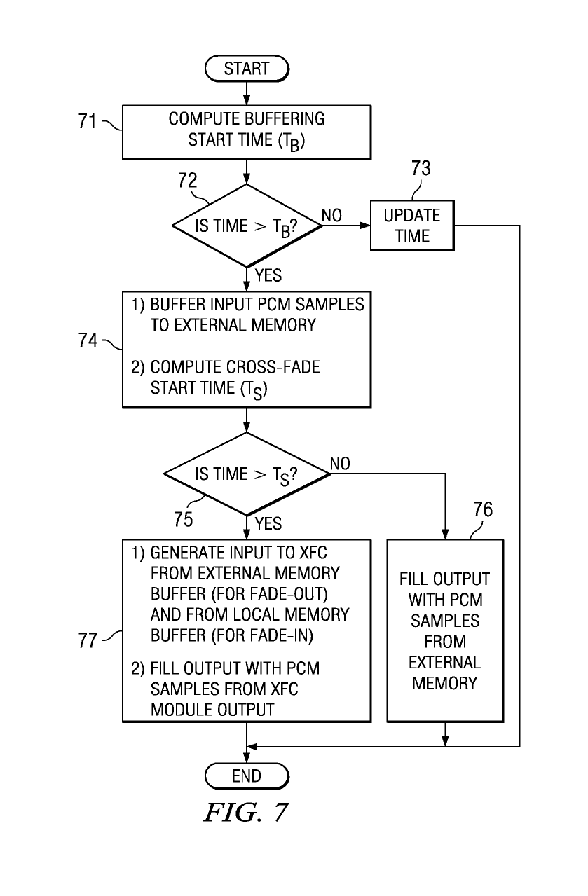

FIG. 7 is a flow-chart illustrating the method for achieving cross-fade apparatus through a flow-chart representation. The buffering start time T_{B} is determined in step 71. Update playback time in step 73 if buffering time is less than the T_{B} in step 72. If current playback time is greater than or equal to buffering start time in step 72, Stream data to samples reservoir and update the playback time in step and compute cross-fade start time T_{S} in step 74. Check if playback time has exceeded cross-fade time T_{B} in step 75. If cross-fade time T_{B} is not yet reached data is streamed to digital-to-analog converter from samples reservoir in step 76. If cross-fade time T_{B} is reached: a) fade-out the Stream from samples reservoir, b) fade-in the Stream from decoder as the decoder would have started decoding fade-in Stream, c) mix the fade-in and fade-out audio Streams, and d) Stream the cross-fade Stream to the digital-to-analog converter as shown in step 77. The above mentioned process continues for the fade-in Stream to cross-fade with next Stream for fade-in, on completion of present cross-fade.

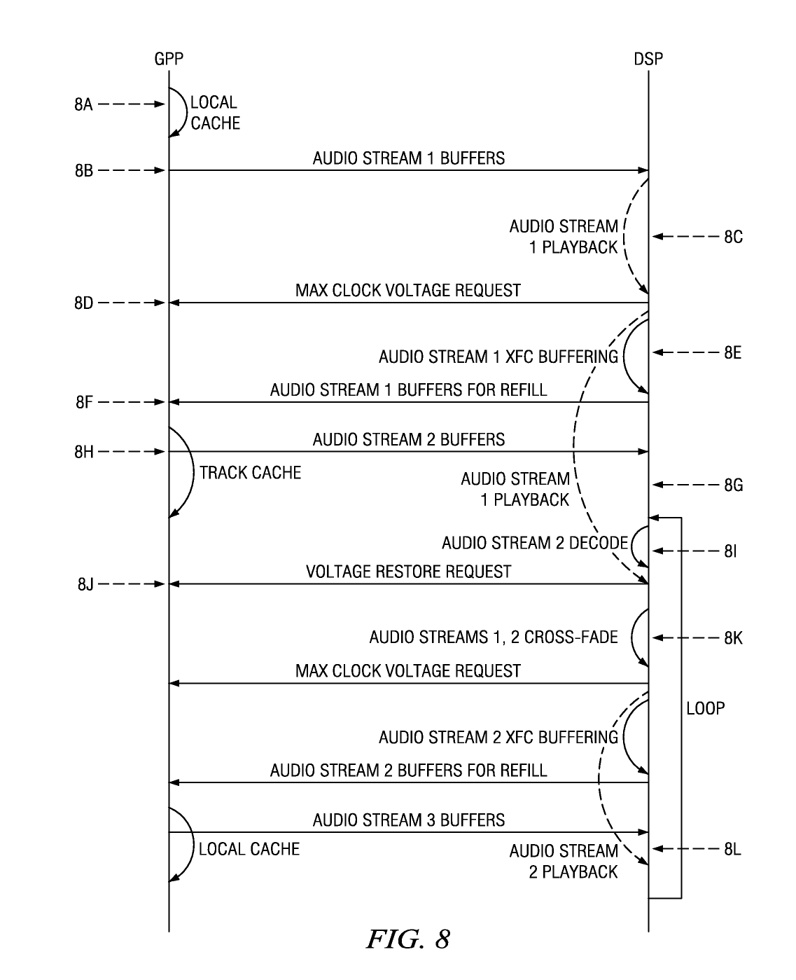

FIG. 8 is the sequence diagram of the apparatus for reproducing an audio Stream with cross-fade illustrating dynamic clock change. The sequence diagram illustrates the cross-fade procedure with the presence of a general purpose processor and a digital signal processor, (though a dual processor core is not mandatory) for grouping control and signal processing, respectively. The description flows from top to bottom of the diagram corresponding to a timeline. In step 8A, the audio Stream 1 is entered in a buffer storage or track cache associated with the post cross-fade controller Streams. In step 8B, the first audio Stream stored in buffer memory buffers are provided to playback apparatus. In step 8C, the audio Stream 1 is applied to the digital-to-analog converter and applied to the speakers for play back. In step 8D on reaching the buffering start time, the clock frequency change request is issued. A clock frequency change might require an operating voltage change prior to increase in clock frequency. In step 8E, the samples reservoir is enabled for buffering, once clock setting is completed. In apparatus where dynamic clock change is not permissible while audio playback is ongoing, the apparatus could operate at an increased clock over the entire duration of the playback, thus eliminating the need for clock change. In this case, the samples reservoir is filled from start of Stream decode until the end, gradually increasing the level of samples in the samples reservoir and reaching the level needed for fade-duration when the Stream reaches the end. On completion of decoding the track buffers, the track buffers are available for refill in step 8F. In step 8G, the audio Stream 1 playback continues from the samples reservoir. In step 8H, the next audio Stream 2 buffers, which are already buffered before the audio Stream 1 buffers are returned for refill, are sent for fade-in and playback. The fade-in audio Stream 2, if different, requests the apparatus to install corresponding decoder in place of the previous decoder. In apparatus where two or more audio Streams can not be buffered due to limited memory, the fade-in Stream is buffered in receiving buffers during refill. In this case, the samples reservoir has to have an adequate number of samples (in addition to fade-out duration) to handle the delay arising from track buffer refill operation. In step 8I, the fade-in audio Stream 2 starts, while fade-out audio Stream 1 playback is in progress. The fade-in audio Stream 2 progresses a few frames for which the on-chip memory has space for holding the PCM samples. Then, the decoder idles until fade-in operation starts. In step 8G, the clock is restored to the minimum required by the cross-fade controller for playback, if the clock was increased in above step 8D. The clock once restored to the minimum required, the core voltage can be lowered to the operating voltage needed for the selected frequency. The voltage and frequency tables can be pre-computed and saved in a table format. In step 8K, once the samples remaining in samples reservoir correspond to fade-out duration in playback time, the cross-fade operation is started. This procedure is applicable in the case of fade-out time greater-than or equal-to fade-in time. Otherwise, fade-in starts first followed by fade-out so as to meet different fade-in and fade-out time. On completion of fade-in operation, the Stream plays back at constant gain, as mentioned in above step c. Further processing continues by repeating steps 8D to 8I till end of playback.

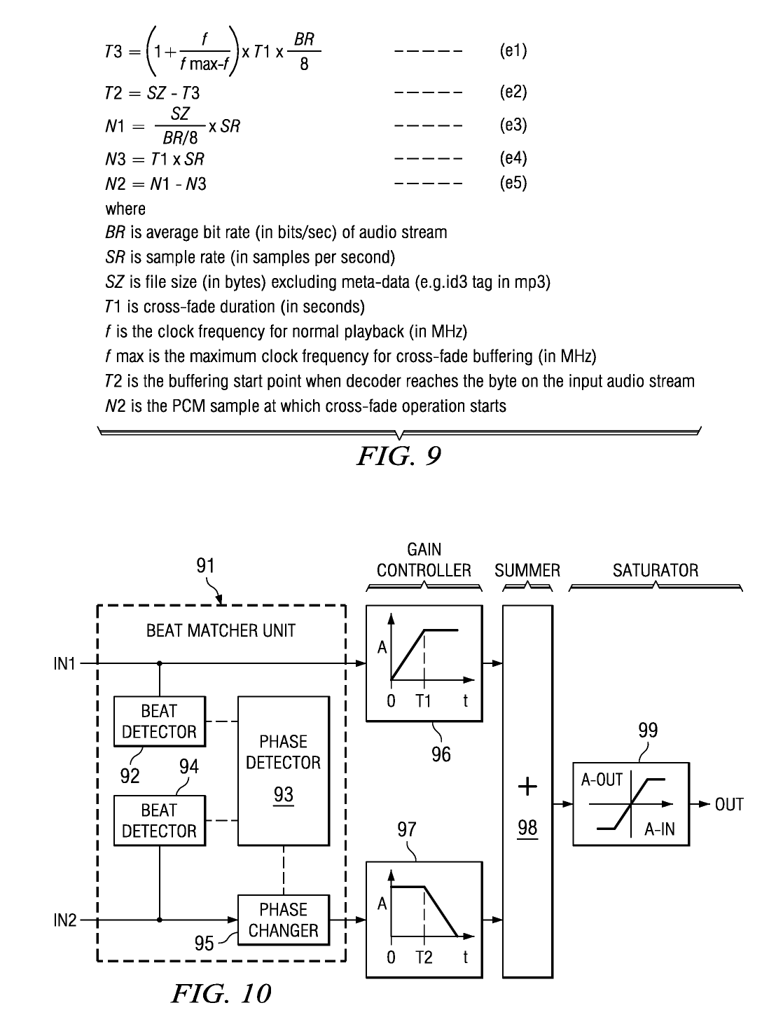

FIG. 9 provides the time computation for start of samples reservoir buffering and cross-fade procedure. Equation e1 computes the amount of input compressed/uncompressed data remaining in the present Stream T3 when samples reservoir buffering need to be started, by the use of present clock frequency f and maximum possible clock frequency fmax (in-case of dynamic frequency change), fade-out duration T1, and average bit-rate of audio Stream BR. Equation e2 computes the byte position on input Stream to decoder T2 at which the samples reservoir needs to be enabled for buffering PCM samples. The file SZ is the amount of input Stream containing audio data (excluding meta-data, and file headers/trailers). In case of the apparatus where dynamic clock change is not possible, the equations e1 and e2 can be used for computing the clock required fmax for continuous and gradual reservoir filling throughout the Stream. T2 is set to start of audio Stream and is the worst-case clock required for playback apparatus without samples reservoir buffering. The computation can be done off-line, and the clock frequency table generated. The clock frequency should account for worst case clock requirement by any decoder if multiple format cross-fade were to be supported. Otherwise, worst case clock frequency for a given decoder needs to be used in the apparatus. Fade-out start time in terms of samples played by DAC can be determined by equation e5. In case of bitStream errors encountered by decoder, the file size is adjusted and the time parameters recomputed. Also to handle variable bitrate Streams, time computation need to be performed periodically at a sufficient interval (about 1/10^{th} of fade-out duration) to ensure fade-out duration accuracy. Also, it is possible to detect fade-out time by detecting samples reservoir level after the end of input Stream. The samples reservoir would hold as much as fade-out duration samples, when fade-out needs to be signaled or started.

Referring to FIG. 10 and the cross-fade algorithm, a beat matcher unit 91 takes two input Streams, matches the beats of the fade-in and fade-out Stream in the beat detectors 92, 94, in phase detector 93 and phase changer 95, applies fade-in and fade-out gain to audio Streams by gain controllers 96, 97, and performs saturated sum of fade-in and fade-out Streams in summer 98, and saturator 99. The beat matcher unit 91 is optional and if used, the processing unit should have enough cycles to perform beat matching. Beat detection and phase changer needs to be enabled only during end of fade-out Stream (maybe a few seconds) before fade-out operation starts, so that fade-out Stream beats can be phase aligned with fade-in Stream. The phase change needs to be applied gradually so as to reduce audible skips or pitch change (depending upon method of choice of implementation of phase changer). Dynamic clock change is suitable to handle this increased load during brief periods. If dynamic clock change is not possible, apparatus needs to be clocked higher as compared to normal to accommodate beat matcher 91 near to the fade-out time. The saturation is to avoid overflow in finite-precision arithmetic module. For positive 45 degree gain curve slope for fade-in and 45 degree negative slope for fade-out gain curve, the clipping or saturation is not essential. The gain curves for fade-in and fade-out also could be set in such a way as to create headroom which prevents clipping/saturation of the resultant of mixer. The side-effect is loss of dynamic range. In case of continuous playback of audio Streams, the same Stream needs to be faded-in at the start and faded-out at the end. The beat matcher and gain controller 95, 96, 97 should alternate between the 2 input signals to the summer 98. In simple terms, the same Stream is switched between the inputs to cross-fader inputs IN1 and IN2. That is to say, the Stream starts on fade-in input (IN1) and as soon as fade-in is completed the Stream is switched to fade-out input (1N2) in FIG. 10. However, the fade-out operation or gain controller is applied only for the fade-out duration at the end of Stream.

### 2. Operation of the Preferred Embodiment

The apparatus consists of an audio/speech decoder, sample rate converter, and cross-fade module running on a hardware comprising of one or more processors with internal memory, direct memory access (DMA), external memory, external memory interface (EMIF), variable clock for processor, storage media like hard-disk drive (HDD) and flash, and D/A converter (DAC). A phase-locked-loop (PLL) can be used for varying processor clock. DMA is used for transferring data from/to external memory to/from internal (on-chip) memory. The apparatus can support dynamic clock change of processor while playing audio for better optimization. The storage media containing Streams for reproducing shall support data throughput greater than that encountered during normal playback (1× speed).

The cross-fade algorithm consists of wave envelope shaper (gain controller), and saturated summer in the simplest form. The cross-fader can contain a beat matcher to align the beats of the Streams being mixed. The beat matcher comprises a beat detection of the Streams being mixed and a phase changer to align the phase of the beats. The phase changer is applied on the fade-out Stream. Phase changer could expand or compress audio signal in time-domain to achieve beat alignment.

The Stream for fade-out is read at higher speed from media storage device and decoded, when the buffering time is met (until the buffering time is reached, decoding continues at normal speed). The decoded audio samples are placed in samples reservoir, while playback continues by fetching the PCM samples from samples reservoir. The decoding is performed at a faster pace than playback so as to generate fade-out amount of samples in samples reservoir. As the Stream ends, the external memory would hold PCM samples corresponding to fade-out time. At this time, the fade-in Stream is decoded at normal playback speed and fed to cross-fade module along with fade-out Stream from external memory. The cross-fade module performs the cross-fading operation. The method continues for the present Stream and the reproducing system is turned off or the cross-fade effect is turned off.

In apparatus capable of handling dynamic clock change of processor when the audio playback is continuing, further optimization is possible by increasing clock to maximum possible before enabling samples reservoir filling and restoring the clock once the fade-out Stream reaches end. The dynamic clock change would also optimize power efficiency when Streams of different format need to be cross-faded, since different decoders require varying processor capability.

In case of Streams of different audio formats to be cross-faded, the decoder program and data memory can be overlaid so as to optimize memory usage. Only one decoder is active in the current innovation, thus enabling overlaying of decoder memory for different formats. That is, at the end of fade-out Stream (samples reservoir holds as much or more PCM samples corresponding to Cross-Fade Duration), the decoder for fade-in Stream is loaded onto fade-out Stream decoder.

Although the present invention has been described with respect to the preferred embodiment and drawings of the invention, it will be apparent to those skilled in the art that various adaptations, modifications, and alterations may be accomplished without departing from the spirit and scope of the present invention. Accordingly, it is to be understood that the accompanying drawings as set forth hereinabove are not intended to limit the breadth of the present invention, which should be inferred only from the following claims and their appropriately construed legal equivalents.

What is claimed is:

1. An audio reproducing apparatus, the apparatus comprising:
an output unit for combining a first audio Stream and a second audio Stream in response to a cross-fade algorithm;
a first apparatus for processing the first audio Stream to be applied to the output unit, the first apparatus including a memory unit, the memory unit storing a portion of the first audio Stream to be combined with the second audio Stream; and
a second apparatus for processing the second audio Stream, the second audio Stream being applied to the output unit.

2. The audio reproducing apparatus as recited in claim 1 further comprising a clock having a variable rate, the variable rate permitting the first audio Stream to be processed before the beginning of the second audio Stream.

3. The audio reproducing apparatus as recited in claim 1 further comprising a sample rate converter, the sample rate converter synchronizing the processing of the first audio Stream with the processing of the second audio Stream, the sample rate converter increasing the processing rate of the first audio Stream.

4. The apparatus as recited in claim 1 further comprising:
a decoder in both audio Streams; and
a post-processing unit in both audio Streams.

5. The audio reproducing apparatus as recited in claim 1, the apparatus comprising:
a buffer memory coupled to the output terminal output unit, the buffer memory buffering the combined first and second audio Streams;
a digital-to-analog converter coupled to the buffer memory unit; and
a speaker unit coupled to the output of the analog-to-digital converter.

6. The apparatus as recited in claim 1 wherein the first and second apparatus include a storage unit storing portions of the audio portions of the audios Streams processed therein.

7. A method of combining two audio Streams with a cross-fade process, the method comprising:
processing a first audio Stream;
storing the portion of the processed first audio Stream to be cross-faded with a second audio Stream;
processing a second audio Stream; and
cross-fading the stored portion of the processed first audio Stream with a beginning portion of the processed second audio Stream.

8. The method as recited in claim 7 wherein the first audio Stream is processed prior to the beginning of the processed second audio Stream.

9. The method as recited in claim 7 further comprising rate-changing the first audio Stream to synchronized the first and second audio signal portions being cross-faded.

10. The method as recited in claim 7 further comprising:
storing an end portion of the second audio Stream; and
cross-fading the end portion of the second audio Stream with a beginning portion of the next first audio Stream.

11. The method as recited in claim 7 further comprising:
storing a portion of the processed second audio Stream to be cross-faded with a first audio Stream;
processing the first second audio Stream; and
cross-fading the stored portion of the processed second audio Stream with a beginning portion of the processed first audio Stream.

12. The method as recited in claim 7 further comprising buffering the first audio Stream, the second audio Stream, and the combined first and second audio Stream prior to applying the audio Streams to an analog-to-digital converter.

13. The method as recited in claim 11 further comprising applying the output signals of the analog-to-digital converter to a broadcast system.

14. An apparatus for combining a first audio Stream and a next audio Stream, the apparatus comprising:
a first decoder for processing the first audio the first audio Stream;
a first storage unit for storing the end portion of the first audio Stream;
a next decoder unit for decoding the next audio Stream;
a next memory unit for storing an end portion of the next audio Stream; and
a cross-fade controller, the cross-fade controller combining the stored end portion of the first audio and the beginning portion of the next audio Stream according to a cross-fade algorithm.

15. The apparatus as recited in claim 14 wherein the non-cross-faded portions of the first and the next audio Stream are forwarded, unaltered, by the cross-fade controller.

16. The apparatus as recited in claim 14 further comprising a sample rate converter, the sample rate converter synchronizing the end portion of the first audio Stream stored in the storage unit with the beginning portion of the next audio Stream.

17. The apparatus as recited in claim 16 further comprising a second sample rate converter, the second sample rate converter synchronizing an end portion of the next audio Stream with a next first audio Stream.

18. The apparatus as recited in claim 14 further comprising a digital-to-analog converter, the output signal of the cross-fade controller being applied to the digital-to-analog converter.

19. The apparatus as recited in claim 14 further comprising a timing unit, the timing unit determining the onset of the cross-fading procedure.
